(19) United States
(12) Patent Application Publication
(10) Pub. No.: US 2026/0126766 A1
(43) Pub. Date: May 7, 2026

(54) Context-Aware Automation Systems With Integrated Seamless Control And Adaptive Environmental Adjustments

(71) Applicant: Khalid Hamdon, Calgary (CA)

(72) Inventor: Khalid Hamdon, Calgary (CA)

(21) Appl. No.: 19/379,436

(22) Filed: Nov. 4, 2025

Related U.S. Application Data
(60) Provisional application No. 63/717,202, filed on Nov. 6, 2024.

(51) Int. Cl. G05B 15/02; G01J 1/42; G01L 1/20; G01S 13/04

(52) U.S. Cl. CPC G05B 15/02; G01J 1/4204; G01S 13/04; G01L 1/20

(57) ABSTRACT

A building automation system includes a ceiling-mounted sensor module comprising a millimeter-wave radar sensor, thermal array sensor, and ambient light sensor. The millimeter-wave radar sensor detects stationary occupants by measuring chest movements corresponding to breathing patterns and generates three-dimensional position coordinates for each detected occupant. A control unit processes sensor data locally and automatically controls a lighting system, window covering system, climate control system, and audio system based on occupancy patterns and environmental conditions. The control unit adjusts lighting brightness and color temperature according to a solar schedule determined from GPS coordinates and time of day, and prevents lighting activation when ambient light levels exceed a predetermined threshold despite detected occupancy. The system operates independently during network disruptions through local data processing within the residential structure.

### CROSS REFERENCE TO RELATED APPLICATIONS

This application claims the benefit and priority of U.S. Provisional Application Ser. No. 63/717,202 filed on Nov. 6, 2024, which is hereby incorporated by reference including all appendices as if fully set forth herein.

### FIELD

The present disclosure relates to building automation and occupancy-aware environmental control systems that employ multi-modal sensing (for example, millimeter-wave radar, thermal, and ambient light) to coordinate lighting, shading, HVAC (Heating, Ventilation, and Air Conditioning), audio, and safety functions in residential and commercial spaces.

### SUMMARY

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a sensor module positioned in a ceiling, the sensor module may include: a millimeter-wave radar sensor configured to detect stationary occupants by measuring chest movements corresponding to breathing patterns, where the millimeter-wave radar sensor generates three-dimensional position coordinates for each detected occupant; a thermal array sensor having a low resolution configured to generate heat signatures of occupants; and an ambient light sensor configured to measure ambient light levels; a control unit operatively coupled to the sensor module and configured to receive and process sensor data from the millimeter-wave radar sensor, the thermal array sensor, and the ambient light sensor; a lighting system operatively connected to the control unit, where the control unit is configured to: adjust brightness and color temperature of the lighting system based on a solar schedule determined from GPS coordinates and time of day; and automatically prevent activation of the lighting system when the ambient light sensor detects ambient light levels exceeding a predetermined threshold despite detecting occupancy via the millimeter-wave radar sensor; a window covering system operatively connected to the control unit and configured to automatically adjust window coverings based on detected user routines and external environmental conditions; a climate control system operatively connected to the control unit and configured to adjust temperature and humidity based on occupancy patterns detected by the millimeter-wave radar sensor; and an audio system integrated with the control unit and configured to play audio notifications selectively in rooms with detected occupancy, where the control unit processes all sensor data locally within a residential structure, enabling continued operation during network disruptions. Other embodiments of this aspect include corresponding computer systems, apparatus, and computer programs recorded on one or more computer storage devices, each configured to perform the actions of the methods.

Implementations may include one or more of the following features. The building automation system where the millimeter-wave radar sensor operates in a frequency range of 57-64 GHz, with other ranges being contemplated based on the sensor. The thermal array sensor has a resolution of 510 total pixels or less. The ambient light sensor is configured to measure ambient light levels in a range of approximately 1 to 65,535 lux, inclusive. The sensor module further may include a force-sensing resistor integrated into furniture, and where the control unit is configured to validate occupancy detected by the millimeter-wave radar sensor using pressure data from the force-sensing resistor. Pressure sensing can alternatively be achieved with piezoelectric elements, load cells, capacitive sensors, or equivalent transducers.

The millimeter-wave radar sensor is further configured to measure breathing rate and heart rate of detected occupants without physical contact, and where the control unit is configured to activate a sleep mode when detecting breathing rates in a predetermined sleep range combined with sustained stationary occupancy. The control unit is further configured to: track a direction of travel and velocity of a user via geofencing; activate the climate control system to pre-condition the residential structure before the user arrives based on calculated arrival time; and automatically clear any manual overrides to the lighting system, the window covering system, or the climate control system when the user departs the residential structure. The millimeter-wave radar sensor is configured to distinguish between adults, children, and pets by analyzing radar cross-section signatures, and where the audio system is configured to mute audio notifications in rooms where the millimeter-wave radar sensor detects a child-sized radar cross-section combined with breathing patterns indicating sleep. Implementations of the described techniques may include hardware, a method or process, or computer software on a computer-accessible medium.

One general aspect includes a method for context-aware building automation. The method also includes detecting occupancy in a room using a millimeter-wave radar sensor, where the detecting includes measuring chest movements corresponding to breathing patterns to detect stationary occupants; generating three-dimensional position coordinates for each detected occupant using the millimeter-wave radar sensor; detecting heat signatures of the detected occupants using a thermal array sensor having a low resolution; determining a current activity state of the detected occupants by analyzing at least: breathing rate measured by the millimeter-wave radar sensor, duration of stationary occupancy measured by the millimeter-wave radar sensor, and movement pattern intensity measured by the millimeter-wave radar sensor. The method also includes automatically adjusting environmental conditions in the room based on the determined activity state without requiring manual user input, where the adjusting includes: activating a sleep mode may include dimming lights and reducing HVAC activity when the breathing rate is in a predetermined sleep range and the stationary occupancy exceeds a predetermined duration threshold, increasing lighting intensity when the movement pattern intensity in a kitchen area exceeds a predetermined threshold for a predetermined time period indicating cooking activity, and dimming lights and closing window coverings when detecting media playback. The method also includes processing all sensor data and automation decisions locally within a residential structure. Other embodiments of this aspect include corresponding computer systems, apparatus, and computer programs recorded on one or more computer storage devices, each configured to perform the actions of the methods.

Implementations may include one or more of the following features. The method where the millimeter-wave radar sensor operates in a frequency range of 57-64 GHz. The thermal array sensor has a resolution of 510 total pixels or less. The predetermined sleep range is 12-15 breaths per minute. The method may include: measuring ambient light levels using an ambient light sensor; determining that the ambient light levels exceed a predetermined threshold; and preventing activation of artificial lighting despite detecting occupancy when the ambient light levels exceed the predetermined threshold. The method may include: detecting pressure on furniture using a force-sensing resistor integrated into the furniture; detecting breathing vibrations through pressure variations measured by the force-sensing resistor; and validating the occupancy detected by the millimeter-wave radar sensor using the pressure data from the force-sensing resistor to eliminate false positive detections. Implementations of the described techniques may include hardware, a method or process, or computer software on a computer-accessible medium. In representative examples, a low-resolution thermal array such as less than or equal to 510 pixels is used, and higher resolutions are contemplated. Pressure sensing can alternatively be achieved with piezoelectric elements, load cells, capacitive sensors, or equivalent transducers.

One general aspect includes a method for automated environmental control using sensor fusion. The method also includes receiving first occupancy data from a millimeter-wave radar sensor positioned in a ceiling, where the first occupancy data includes three-dimensional position coordinates generated by detecting chest movements corresponding to breathing patterns; receiving second occupancy data from a thermal array sensor positioned in the ceiling, where the second occupancy data includes heat signatures corresponding to human body temperature; receiving third occupancy data from a force-sensing resistor integrated into furniture, where the third occupancy data includes pressure measurements and breathing vibrations; receiving environmental data from an environmental sensor cluster positioned in the ceiling, where the environmental data includes at least ambient light levels, temperature, humidity, and co₂ concentration; determining a validated occupancy state by cross-validating the first occupancy data, the second occupancy data, and the third occupancy data, where the cross-validating eliminates false positive occupancy detections from pets or inanimate objects; determining an activity classification by analyzing patterns in the first occupancy data, the second occupancy data, the third occupancy data, and the environmental data; automatically generating control commands for at least a lighting system, a climate control system, and a window covering system based on the validated occupancy state, the activity classification, and the environmental data; and executing the control commands locally without cloud processing. Other embodiments of this aspect include corresponding computer systems, apparatus, and computer programs recorded on one or more computer storage devices, each configured to perform the actions of the methods. Pressure sensing can alternatively be achieved with piezoelectric elements, load cells, capacitive sensors, or equivalent transducers.

Implementations may include one or more of the following features. The method where the heat signatures corresponding to human body temperature are within a human-thermal band of approximately 30 to 40° C. inclusive. The determining the activity classification may include: detecting that the first occupancy data indicates a breathing rate in a predetermined sleep range; detecting that the third occupancy data indicates sustained pressure on a bed with breathing vibrations; and classifying the activity as sleep based on the breathing rate and the sustained pressure with breathing vibrations. The predetermined sleep range is 12-15 breaths per minute (other ranges can be used). The method may include: detecting manual intervention with the lighting system by monitoring for changes in lighting state not initiated by the control commands; suspending generation of lighting control commands for a predetermined time period in response to detecting the manual intervention; tracking user location via geofencing; and resuming generation of lighting control commands when geofencing indicates the user has departed a residential structure, automatically clearing the manual intervention. Implementations of the described techniques may include hardware, a method or process, or computer software on a computer-accessible medium.

### BRIEF DESCRIPTION OF THE DRAWINGS

FIG. 1 is a block diagram illustrating an example building automation system including a control unit, sensor module, and multiple controlled subsystems.

FIG. 2 is a system data flow diagram illustrating the data pathways and processing hierarchy between the sensor module, control unit sub-components, controlled subsystems, and geofencing system.

FIGS. 3A and 3B are a flowchart illustrating a context-aware automation method for detecting occupancy, determining activity states, and automatically adjusting environmental conditions without manual user input.

FIGS. 4A and 4B are a flowchart illustrating a sensor fusion and cross-validation method for receiving data from multiple sensor types, validating occupancy through cross-validation, and generating control commands based on validated occupancy states.

FIG. 5 is a state diagram illustrating the automation states of the building automation system and the conditions that trigger transitions between states.

FIG. 6 is a diagrammatic representation of an example computer system suitable for implementing the control unit of the building automation system.

### DETAILED DESCRIPTION OF EXAMPLE EMBODIMENTS

Unless otherwise stated, numeric values presented herein are representative examples and can be varied, replaced with ranges, or expressed as inequalities where supported by the specification. Named components can be substituted with their functional equivalents. The term comprising is used in the claims in a non-exclusive sense and should be interpreted to allow the inclusion of additional elements and operations beyond those explicitly listed. The specification supports alternative arrangements that a person of ordinary skill in the art would recognize as equivalent based on the disclosed functionality.

While residential deployments are described for clarity, the same architecture applies to multi family, hospitality, healthcare, retail, educational, enterprise, industrial, and transportation environments. Zones can represent rooms, bays, beds, desks, aisles, or vehicle cabins. Policies can be scripted or learned and can be conditioned on schedules, geofencing, utility pricing, or explicit user preferences. Implementations can honor manual overrides with automatic reconciliation based on timeouts or presence context.

As specific examples, sleep routines can dim luminaires, reduce HVAC fan duty, and close window coverings. More generally, any state change can map to any subset of controllable loads, including security, access control, water shutoff, leak mitigation, media devices, appliances, and exterior equipment. A thermal array can be any array having sufficient sensitivity to distinguish human thermal signatures. In representative cases a low resolution array such as less than or equal to 510 pixels is used, but higher resolutions are also contemplated. A radar front end can operate in any band suitable for indoor sensing, such as short range bands including, by way of example, 76 to 81 GHz. Ambient light sensors can report illuminance over wide dynamic ranges such as 1 to 65,535 lux or an equivalent normalized measure. Pressure sensing can be achieved by discrete force sensing resistors, piezoelectric elements, or instrumented seat rails.

The systems, methods, and devices described herein are not limited to a specific sensor make, model, mounting location, communication protocol, or frequency band. In various embodiments, an occupancy sensor can include one or more modalities selected from millimeter wave radar, ultra wideband radar, ultrasonic transducers, time of flight ranging, lidar, computer vision pipelines that operate on privacy preserving silhouettes, pressure sensors such as force sensing resistors or load cells, and acoustic classifiers. A sensing unit can be mounted in ceilings, walls, luminaires, furniture, or portable fixtures, and can communicate over wired or wireless links such as Power over Ethernet, RS 485, CAN, Wi Fi, Wi Fi HaLow, Bluetooth Low Energy, Thread, or an equivalent protocol. A controller can be implemented as a dedicated embedded appliance, a distributed set of microcontrollers, or a virtualized process executing on a general purpose compute platform. Decisions can be performed locally, at an edge gateway, or on a cloud service while preserving user privacy. In representative implementations, safety critical routines execute locally with optional cloud augmentation.

### Overview

The disclosed technology presents a sophisticated approach to automation systems, specifically tailored for residential environments, with specific applications for commercial and industrial environments. It introduces a context-aware system that integrates seamlessly into the home, providing intelligent, real-time control of various household functions. Unlike conventional automation systems, which rely on manual inputs through HMIs (human-machine interfaces), applications, switches, or voice commands, this system minimizes (and in some embodiments eliminates) the need for direct user interaction, allowing the home to respond automatically to occupants'behaviors. While example embodiments refer to “building automation” the present disclosure is not so limited and the teachings of this disclosure can be applied in other environments.

One element of the system is a discreet sensor module, installed in the ceiling, designed to blend into the home's aesthetic. In other embodiments, the control unit and sensor module can be installed or hidden in any portion of the structure where an example system is installed. The sensor monitors user behavior and environmental conditions, enabling dynamic adjustments to lighting, climate, window coverings, and more, without requiring manual intervention. The system detects room occupancy, time of day, and other contextual factors to ensure optimal environmental conditions. Other example inputs can include, but are not limited to, temperature, humidity, ultraviolet light, motion, millimeter wave, and other similar input.

In certain embodiments, when measured ambient illuminance exceeds a configured threshold, the controller inhibits activation of artificial lighting even when occupancy is detected, thereby avoiding unnecessary lighting during bright daylight conditions. In some embodiments, the thermal array classifies human presence by detecting heat signatures proximate to 37° C. and rejecting backgrounds outside that range. In various embodiments, the millimeter wave radar sensor operates in the 76 to 81 GHz band to provide high-resolution breathing and heart-rate monitoring while maintaining compact antenna geometry. In certain embodiments, the radar signal processor extracts both breathing rate and heart rate from chest micromotions using Doppler and range-frequency analyses, enabling sleep-state detection without physical contact.

One example feature is an adaptive lighting system that adjusts both brightness and color temperature in real time, synchronizing with the user's natural rhythms. Lights are cooler and brighter in the morning to promote alertness and gradually dim and warm in the evening to support relaxation. The system includes nighttime lighting, where soft red ambient lights guide users safely through the home without disrupting sleep. This intelligent lighting promotes both user comfort and energy efficiency by ensuring lights operate only when necessary.

In addition to improving or adhering to circadian health, the systems disclosed herein also enhance the aesthetic of the home. For example, when inputs are combined and/or coupled with room occupancy, this feature eliminates or reduces the need for having light switches installed. Of course, if installed, they still operate as expected.

The system's window coverings automatically adjust based on time of day, weather, and user routines, optimizing natural light and offering privacy while protecting interior furnishings from UV exposure. This control also contributes to energy efficiency by regulating solar heat gain, reducing heating and cooling requirements.

Additionally, the system integrates with the home's doorbell and audio systems, directing chimes only to occupied rooms, avoiding disturbance to unoccupied areas or sleeping rooms. Visual cues and ambient lighting can notify occupants of visitors, enhancing convenience and security without intrusive alerts.

The climate control adjusts temperature and humidity based on occupancy patterns and external conditions, ensuring comfort while minimizing energy consumption. The system adjusts to preferences or learns over time to automatically maintain ideal conditions, such as preconditioning rooms at specific times of day.

The system can also employ geofencing technology that tracks users'location, direction, and speed of travel. This allows for intelligent preconditioning when occupants are headed home or automated energy-saving adjustments when they're leaving. By analyzing both distance and velocity, the system can precisely time climate adjustments to ensure optimal comfort upon arrival while maximizing efficiency during absences.

Privacy and reliability are key components of the system, with all processes handled locally within the home. This local processing ensures that the system operates independently of external cloud services, maintaining privacy and continuity of function even during internet disruptions.

Designed for flexibility, the system supports manual overrides when desired. Users can take control of specific functions, such as lighting or climate, with conventional interactions. Visual indicators provide feedback when overrides are active, and the system can reset to its automated state after a designated period. The system intelligently manages override states, including but not limited to using geofencing to detect when occupants depart from the home. This ensures that any manual overrides automatically clear upon departure, returning the home to its efficient automated mode and preparing it for the occupants'eventual return.

The system's versatility extends to entertainment integration, enabling it to trigger specific scenes, such as dimming lights and closing window coverings such as curtains when playing media. Additionally, it can automatically play pre-selected music in different rooms, enhancing the ambiance based on the space, such as energizing music in a gym or calming audio in a relaxation area.

This building automation system differs from traditional solutions by providing a context-aware, intelligent experience that reduces or eliminates the need for manual user input. It integrates seamlessly into the home, minimizing visible technology and optimizing the living environment through automation. By dynamically adapting to the occupants'needs, the system enhances both functionality and the aesthetic experience in luxury homes.

### Example Embodiments

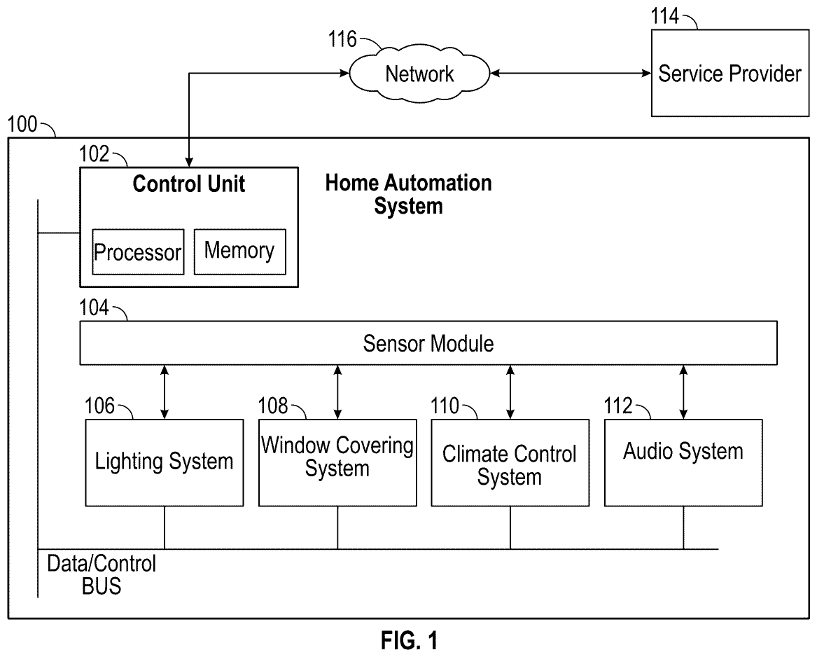

FIG. 1 illustrates an example building automation system 100 designed for seamless integration within a residential environment. The building automation system operates without a traditional user interface, eliminating the need for direct interaction through screens, apps, or voice commands. Instead, the system relies on an array of sensors and a sophisticated control unit to automatically detect environmental conditions and user behavior. This sensor-driven approach enables the system to seamlessly adjust functions like lighting, climate control, and window coverings based on real-time occupancy and environmental factors. By removing the need for manual inputs, the system anticipates the occupants'needs and makes automatic adjustments, such as dimming lights, adjusting room temperatures, or closing blinds, ensuring a fully automated experience. This intuitive design flattens the learning curve for users, allowing even visitors to experience the home's responsive behavior without needing to learn or operate any devices. In certain embodiments, the thermal array sensor having a low resolution of approximately 510 pixels (e.g., 34×15 array) configured to generate heat signatures and position data, where the thermal array sensor includes on-board processing that converts raw thermal data into structured occupancy information.

The building automation system incorporates an advanced logic framework through an array of embedded, pre-configured automation algorithms within the central control unit. These algorithms are engineered to govern the system's response mechanisms to a diverse array of environmental stimuli and inferred user preferences, without necessitating direct human input. The control unit employs a sophisticated, adaptable rules-based architecture enabling real-time, autonomous decision-making capabilities. Upon detection of predefined triggers by the integrated sensor module-including but not limited to changes in occupancy patterns, time of day, or fluctuations in ambient temperature-the control unit dynamically interprets the logic from these algorithms. This interpretation leads to the execution of precise system commands, such as the modulation of ambient light intensity, the automatic adjustment of window coverings, or the optimization of heating, ventilation, and air conditioning settings to enhance comfort, energy efficiency, and security, all tailored to the contextual data without user intervention. In certain embodiments, the ambient light sensor measures illuminance over a dynamic range of 1 to 65,535 lux to support daylight-aware decisions.

During installation, the system can be tailored to the specific preferences and routines of the homeowner. This is achieved by provisioning the control unit with custom logic scripts that reflect user-specific patterns, such as preferred lighting settings at different times of the day, room temperature thresholds, or automated responses to occupancy. Once programmed, the control unit continuously monitors the home environment and makes adjustments without requiring manual input from the user. These scripts can also be updated or reprogrammed to accommodate new preferences or environmental conditions, ensuring the system remains adaptable over time.

The system 100 includes a control unit 102, which is responsible for coordinating the various components and managing the system's operations in real-time. The control unit 102 is operatively connected to a sensor module 104, which could be recessed in the ceiling of the home and configured to detect both occupancy and environmental conditions such as temperature, humidity, and ambient light levels.

The sensor module 200 further comprises wireless communication components including a Bluetooth Low Energy (BLE) radio and a Wi-Fi radio. The Bluetooth radio enables proximity-based presence detection when users carry Bluetooth-enabled devices such as smartphones or wearable devices, allowing user-specific automation customization. The Wi-Fi radio provides network connectivity for data transmission to the control unit and enables advanced presence detection techniques based on Wi-Fi signal disruption patterns caused by human movement within the monitored space.

The environmental sensor cluster includes: a temperature sensor with ±0.5° C. accuracy; a humidity sensor with ±3% RH accuracy; a barometric pressure sensor for weather-responsive automation; a UV index sensor for window covering control to protect furnishings; a VOC (volatile organic compound) sensor for air quality monitoring; and an acoustic sensor for sound level measurement. The environmental data enables context-aware decisions such as increasing ventilation when CO₂ exceeds 1000 ppm or closing window coverings when UV index exceeds predetermined artwork protection thresholds.

The sensor module 104 communicates with multiple subsystems, including a lighting system 106. The lighting system 106 is equipped with both adjustable brightness and color temperature capabilities. These adjustments are dynamically controlled by the control unit 102 based on sensor data received from the sensor module 104. For instance, the system can detect when an occupant enters a room and automatically increase brightness, while in the evening, it shifts the lighting to warmer tones to promote relaxation.

The system 100 also includes a window covering system 108, which is operatively connected to the control unit 102. The window covering system 108 is capable of automatically adjusting blinds or shades in response to both user preferences and external factors such as the time of day or sunlight intensity. For instance, during peak daylight hours, the system 100 can lower the window coverings to reduce UV exposure and manage heat, while in the evening, it raises the coverings to allow for natural light while maintaining privacy. The system can also respond to specific occupant behavior, such as lowering the window coverings in response to the occupant turning on the TV or playing media.

Additionally, the building automation system 100 integrates a climate control system 110, which adjusts the home's temperature and humidity levels based on occupancy and travel patterns detected by the sensor module 104 and control unit 102. The climate control system 110 is designed to optimize comfort while minimizing energy consumption, automatically lowering heating or cooling in unoccupied areas.

The system 100 also features an integrated audio system 112, which works in conjunction with the control unit 102. The audio system 112 is configured to play notifications, such as doorbell chimes, selectively in rooms where the presence of occupants has been detected. In some instances, output of the sensors can be analyzed to differentiate between adults, infants and even pets, for example, based on the size or contour of the signature returned to the sensor, enabling the ability to mute audio notifications in rooms with sleeping infants. In this way, the system 100 ensures that alerts are only delivered where necessary, avoiding disturbance to unoccupied areas. The audio system 112 can also be automated to control the play/pause/stop state, volume, and specific media selected based on occupancy patterns and user preferences.

Additionally, the system 100 extends control to various other integrated subsystems throughout the home. This includes but is not limited to automated management of access points such as doorways, security gates, garage doors, and access control systems, as well as security cameras and alarm systems, entertainment devices such as televisions and streaming media boxes, and landscaping features like sprinkler systems. Each of these subsystems can be intelligently controlled based on occupancy detection and user preferences, creating a cohesive and responsive home environment.

Notably, the control unit 102 processes all data locally within the home, ensuring privacy and reliable operation even in the absence of an external network connection. This local processing capability is critical for maintaining the system's functionality during internet outages, providing uninterrupted control over the home's automation systems.

The building automation system's logic-based framework could be updated remotely, allowing for script modifications without requiring direct access to the control unit 102. This would enable homeowners or authorized technicians to adjust the system's automation behavior in response to changing preferences, routines, or new environmental conditions. Remote provisioning could be achieved through a secure online platform, VPN (virtual private network) or cloud service, where scripts are sent to the control unit over a network. This ensures that the system remains adaptive and future-proof, as adjustments can be made on-the-fly, such as tweaking lighting schedules, modifying climate control thresholds, or adjusting window covering behavior, all without physical interaction. Such remote access would enhance the system's flexibility, ensuring long-term usability and personalization for the homeowner.

The control unit 102 in the building automation system communicates with a service provider 114 over a network 116 to facilitate system updates, remote management, and script modifications. This connection allows the control unit to receive new automation logic or firmware updates from the service provider's servers. The control unit is equipped with networking capabilities that enable it to securely send and receive data over the internet, ensuring continuous synchronization with the service provider. This network communication could also support diagnostics and troubleshooting, allowing the service provider to monitor system performance, diagnose issues, or apply patches without requiring on-site visits. Data exchanged over the network is typically encrypted to protect user privacy and maintain the integrity of the system's functionality, ensuring secure and efficient updates.

The sensor module is configured for recessed ceiling installation. The module is powered via Power over Ethernet (POE), receiving both data connectivity and electrical power through a single RJ45 connection, eliminating separate power wiring requirements. The module includes a spring-based mounting mechanism that secures it in the ceiling cutout and allows tool-free installation and removal for maintenance.

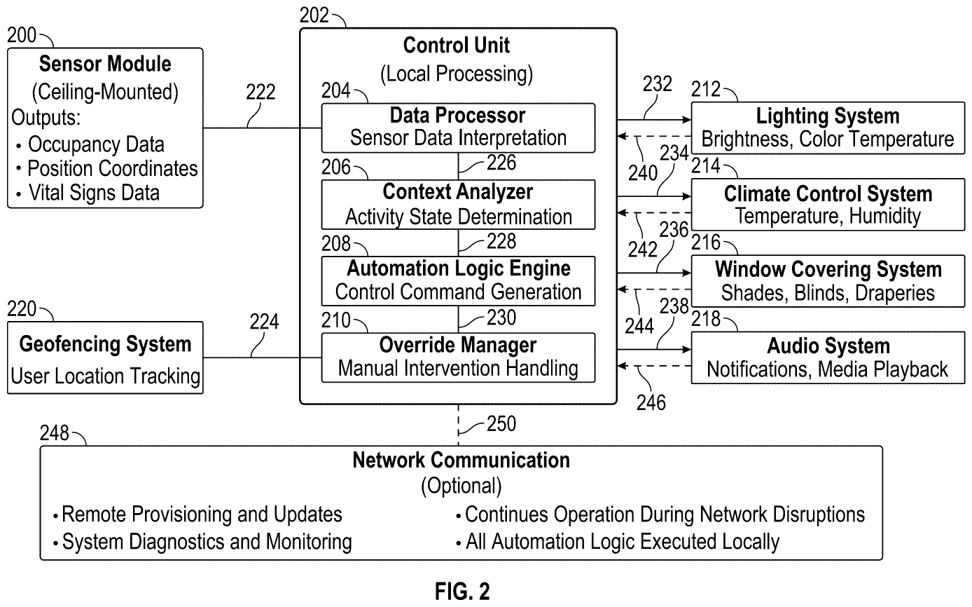

FIG. 2 illustrates a system data flow and sensor integration architecture for the building automation system 100. FIG. 2 provides a detailed view of the data flow pathways, processing hierarchy, and integration relationships between the sensor module 200, the control unit 202, and the various controlled subsystems.

The sensor module 200 is positioned in a ceiling of a residential structure and is configured to collect occupancy data, position coordinates, and vital signs data from an environment. The sensor module 200 generates sensor data that is transmitted to the control unit 202 via data flow pathway 222. The sensor data includes, but is not limited to, occupancy detection information, three-dimensional position coordinates of detected occupants, breathing rate measurements, heart rate measurements, movement pattern data, and environmental condition measurements. The sensor module 200 operates continuously to monitor the environment and provides real-time sensor data to the control unit 202.

The control unit 202 is operatively coupled to the sensor module 200 and is configured to receive and process all sensor data locally within the residential structure. The control unit 202 comprises multiple sub-components that work in a hierarchical processing arrangement to interpret sensor data, determine context, generate automation commands, and manage manual overrides. The control unit 202 is configured to execute all automation logic locally without requiring cloud processing, enabling continued operation during network disruptions.

The control unit 202 includes a data processor 204 that receives the sensor data from the sensor module 200 via data flow pathway 222. The data processor 204 is configured to interpret raw sensor data and convert it into actionable information. The data processor 204 performs functions including, but not limited to, filtering sensor noise, validating sensor readings, extracting occupancy states, determining position coordinates, calculating vital signs parameters, and formatting processed data for subsequent analysis. The data processor 204 outputs processed sensor information to the context analyzer 206 via internal processing flow 226.

The data processor 204 implements a confidence-weighted sensor fusion algorithm. Occupancy indications from multiple sensor modalities receive confidence weights based on signal quality: millimeter-wave radar data receives 0.6-0.8 weight depending on signal strength, thermal array data receives 0.7-0.9 weight depending on heat signature clarity, and force-sensing resistor data receives 0.9-1.0 weight due to definitive physical confirmation. The data processor aggregates weighted scores and validates occupancy when combined confidence exceeds 0.8 threshold. Pressure sensing can alternatively be achieved with piezoelectric elements, load cells, capacitive sensors, or equivalent transducers.

The context analyzer 206 receives the processed sensor information from the data processor 204 via internal processing flow 226. The context analyzer 206 is configured to determine a current activity state of detected occupants by analyzing patterns in the processed sensor information. The context analyzer 206 evaluates multiple parameters including breathing rate, duration of stationary occupancy, movement pattern intensity, position data, and environmental conditions to classify activities. Activity classifications determined by the context analyzer 206 include, but are not limited to, sleep states, cooking activities, media consumption, exercise activities, reading activities, and general presence states. The context analyzer 206 outputs activity state information to the automation logic engine 208 via internal processing flow 228.

The automation logic engine 208 receives the activity state information from the context analyzer 206 via internal processing flow 228. The automation logic engine 208 is configured to generate control commands for controlled subsystems based on the activity state information, environmental conditions, and pre-configured automation logic. The automation logic engine 208 executes rule-based algorithms that map activity states and environmental conditions to specific control actions. For example, when the context analyzer 206 determines a sleep state based on breathing rate in a predetermined sleep range and sustained stationary occupancy, the automation logic engine 208 generates control commands to dim lighting, reduce HVAC activity, and adjust window coverings. The automation logic engine 208 outputs control commands to the override manager 210 via internal processing flow 230.

The override manager 210 receives the control commands from the automation logic engine 208 via internal processing flow 230. The override manager 210 is configured to handle manual intervention by detecting when a user has manually adjusted a controlled subsystem and suspending automated control commands for that subsystem. The override manager 210 monitors feedback signals from the controlled subsystems via data flow pathways 240, 242, 244, and 246 to detect state changes that were not initiated by the control unit 202. When manual intervention is detected, the override manager 210 suspends generation of control commands for the affected subsystem for a predetermined time period. The override manager 210 is further configured to automatically resume automated control when predetermined conditions are met, such as expiration of a timeout period or receipt of location data from the geofencing system 220 indicating user departure from the residential structure.

The geofencing system 220 is configured to track user location, direction of travel, and velocity. The geofencing system 220 provides location data to the override manager 210 via data flow pathway 224. The location data enables the override manager 210 to automatically clear manual overrides when the geofencing system 220 indicates that the user has departed the residential structure. Additionally, the location data enables the automation logic engine 208 to generate pre-conditioning commands when the geofencing system 220 indicates that the user is approaching the residential structure, such as activating the climate control system 214 before the user's estimated arrival time.

The geofencing system 220 establishes concentric geofence zones around the residential structure: an arrival preparation zone at 2-5 km radius, a near-arrival zone at 500 m radius, and a departure confirmation zone at 100 m radius. The system tracks user location via GPS coordinates from mobile devices, calculates velocity and direction of travel using position changes over 5-minute intervals, and estimates arrival time for pre-conditioning commands. The climate control system activates based on calculated arrival time minus thermal mass lag time (typically 15-30 minutes for residential structures) to achieve target temperature upon arrival.

In embodiments employing Bluetooth presence detection, the sensor module 200 detects Bluetooth Low Energy advertising packets from user wearable devices or smartphones within approximately 10-30 meter range. The control unit associates detected Bluetooth device identifiers with specific users, enabling user-specific automation preferences. For example, when User A's device is detected in bedroom, lighting color temperature preference of 2700K is applied, whereas User B's preference of 3200K is applied when only User B's device is detected. The Bluetooth presence detection supplements radar and thermal detection to resolve ambiguous occupancy scenarios.

The control unit 202 generates control commands that are transmitted to multiple controlled subsystems. The lighting system 212 receives control commands from the control unit 202 via data flow pathway 232. The control commands transmitted via data flow pathway 232 specify adjustments to brightness and color temperature of the lighting system 212. The lighting system 212 adjusts lighting based on activity states determined by the context analyzer 206, ambient light levels detected by the sensor module 200, and solar schedule calculations based on GPS coordinates and time of day. The lighting system 212 transmits status feedback to the control unit 202 via data flow pathway 240, enabling the override manager 210 to detect manual interventions.

The automation logic engine 208 calculates solar schedule using GPS coordinates and astronomical algorithms to determine sunrise, sunset, solar noon, and sun position (azimuth and elevation) throughout the day. The lighting system adjusts color temperature from cooler tones (5000-6500K) when solar elevation exceeds 30 degrees to warmer tones (2700-3500K) when solar elevation falls below 20 degrees, with gradual transitions during intermediate periods. Brightness levels similarly adjust from higher intensities during peak daylight hours to lower intensities during dawn and dusk transition periods.

The climate control system 214 receives control commands from the control unit 202 via data flow pathway 234. The control commands transmitted via data flow pathway 234 specify adjustments to temperature and humidity settings. The climate control system 214 adjusts HVAC operation based on occupancy patterns detected by the sensor module 200, activity states determined by the context analyzer 206, and pre-conditioning requirements based on location data from the geofencing system 220. The climate control system 214 transmits status feedback to the control unit 202 via data flow pathway 242, enabling the override manager 210 to detect manual thermostat adjustments.

The window covering system 216 receives control commands from the control unit 202 via data flow pathway 236. The control commands transmitted via data flow pathway 236 specify positioning of shades, blinds, and draperies. The window covering system 216 adjusts window coverings based on detected user routines, external environmental conditions such as sunlight intensity, time of day, and activity states such as media playback. The window covering system 216 transmits status feedback to the control unit 202 via data flow pathway 244, enabling the override manager 210 to detect manual window covering adjustments.

In some instances, automating window cover adjustments is accomplished using a physics-based trigonometric model that calculates the sun's real-time position and penetration depth into a room. By inputting specific geometric parameters like window height and depth of the area to be protected, the system precisely positions blinds to block direct sunlight from targeted zones while maximizing ambient natural light throughout the day. The automation dynamically adjusts covers only when the sun faces the window and weather is clear, sets separate default positions for daytime (when sun isn't directly shining) and nighttime (for privacy), and offers extensive customization options including window orientation, angle tolerance and update frequency, with optional overrides for weather conditions and manual control.

The audio system 218 receives control commands from the control unit 202 via data flow pathway 238. The control commands transmitted via data flow pathway 238 specify audio notification routing, media playback control, and volume adjustments. The audio system 218 plays audio notifications selectively in rooms with detected occupancy based on occupancy data from the sensor module 200. For example, doorbell chimes are routed only to occupied rooms, and audio notifications are muted in rooms where the context analyzer 206 has determined that a child is sleeping based on radar cross-section analysis and breathing patterns. The audio system 218 transmits status feedback to the control unit 202 via data flow pathway 246, enabling the override manager 210 to detect manual audio adjustments.

The control unit 202 is optionally connected to network communication 248 via network connection 250. Network communication 248 enables remote provisioning of automation scripts, firmware updates, system diagnostics, and remote monitoring. However, the control unit 202 is configured to execute all automation logic locally, and the building automation system 100 continues operation during network disruptions. Network communication 248 is illustrated with a dashed line connection 250 to indicate that network connectivity is optional and not required for core automation functions.

The data flow architecture illustrated in FIG. 2 demonstrates the hierarchical processing structure where raw sensor data flows from the sensor module 200 through progressive stages of interpretation, context analysis, and command generation within the control unit 202, ultimately resulting in coordinated control of multiple subsystems. The bidirectional data flow pathways 240, 242, 244, and 246 enable the override manager 210 to maintain awareness of subsystem states and detect manual interventions, enabling intelligent override management. The integration of location data from the geofencing system 220 via data flow pathway 224 enables both pre-conditioning functionality and automatic override clearing, enhancing system intelligence and user convenience.

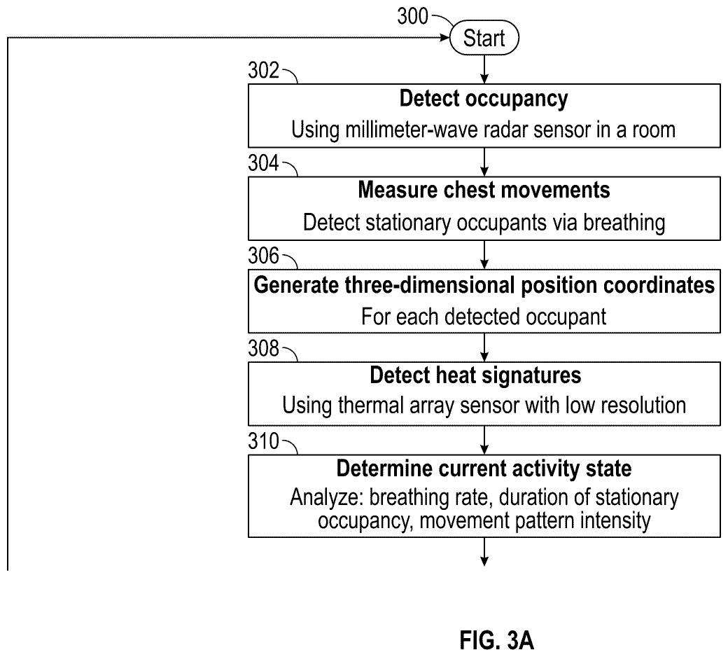

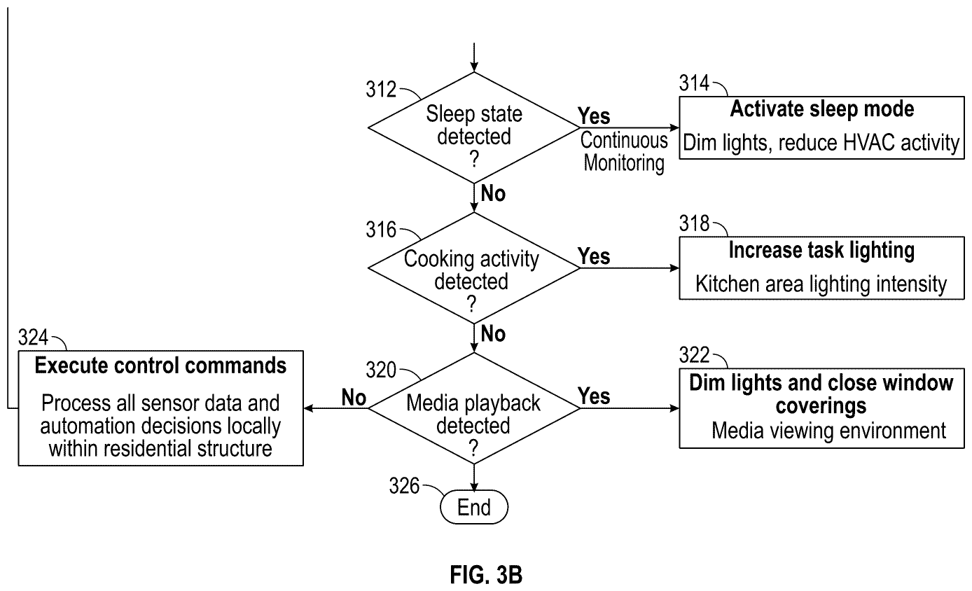

FIGS. 3A and 3B collectively illustrate a context-aware automation method flowchart corresponding to the method claims of the present disclosure, depicting the procedural steps for detecting occupancy, determining activity states, and automatically adjusting environmental conditions without requiring manual user input.

The method begins at start 300 and proceeds to detect occupancy at step 302. At step 302, occupancy in a room is detected using a millimeter-wave radar sensor. The millimeter-wave radar sensor operates continuously to monitor the room environment and detect the presence of occupants. The detection includes both moving and stationary occupants, with the millimeter-wave radar sensor providing real-time occupancy information.

Following occupancy detection at step 302, the method proceeds to measure chest movements (such as those movements corresponding to breathing) at step 304. At step 304, the millimeter-wave radar sensor measures chest movements corresponding to breathing patterns. This measurement capability enables the detection of stationary occupants who would otherwise be undetectable by conventional motion sensors. The chest movements are analyzed to extract breathing rate information and to confirm continued presence of occupants even when they remain motionless for extended periods.

After measuring chest movements at step 304, the method proceeds to generate three-dimensional position coordinates at step 306. At step 306, the millimeter-wave radar sensor generates three-dimensional position coordinates for each detected occupant. The position coordinates include X, Y, and Z spatial information that identifies the precise location of each occupant within the room. This spatial information enables the system to understand not only that the room is occupied, but exactly where within the room each occupant is located.

Following generation of position coordinates at step 306, the method proceeds to detect heat signatures at step 308. At step 308, a thermal array sensor having a low resolution detects heat signatures of the detected occupants. The thermal array sensor provides confirmatory occupancy data that validates the occupancy detected by the millimeter-wave radar sensor. The low resolution of the thermal array sensor ensures privacy by preventing identification of specific individuals while still providing accurate occupancy and position information.

After detecting heat signatures at step 308, the method proceeds to determine current activity state at step 310. At step 310, a current activity state of the detected occupants is determined by analyzing multiple parameters. The analyzed parameters include breathing rate measured by the millimeter-wave radar sensor, duration of stationary occupancy measured by the millimeter-wave radar sensor, and movement pattern intensity measured by the millimeter-wave radar sensor. The determination of activity state involves pattern recognition algorithms that classify occupant behavior based on the combination of these measured parameters.

Following determination of the current activity state at step 310, the method proceeds to a first decision point at step 312. At decision diamond 312, the method evaluates whether a sleep state has been detected. The sleep state determination is based on whether the breathing rate is in a predetermined sleep range and whether the stationary occupancy exceeds a predetermined duration threshold. If the answer at decision diamond 312 is YES, indicating that a sleep state has been detected, the method proceeds to activate sleep mode at step 314.

At step 314, sleep mode is activated, which comprises dimming lights and reducing HVAC activity. The activation of sleep mode creates an environment conducive to continued sleep by minimizing disruptive environmental factors. The lighting is dimmed or turned off, and HVAC activity is reduced to maintain a quiet environment while still providing appropriate temperature control. After activating sleep mode at step 314, the method proceeds to execute control commands 324.

If the answer at decision diamond 312 is NO, indicating that a sleep state has not been detected, the method proceeds to a second decision point at step 316. At decision diamond 316, the method evaluates whether cooking activity has been detected. The cooking activity determination is based on whether the movement pattern intensity in a kitchen area exceeds a predetermined threshold for a predetermined time period. If the answer at decision diamond 316 is YES, indicating that cooking activity has been detected, the method proceeds to increase task lighting 318.

At step 318, lighting intensity in the kitchen area is increased to provide appropriate task lighting for cooking activities. The increased lighting intensity ensures that the occupant can safely perform cooking tasks such as food preparation, cutting, and cooking. After increasing task lighting at step 318, the method proceeds to execute control commands 324.

If the answer at decision diamond 316 is NO, indicating that cooking activity has not been detected, the method proceeds to a third decision point at step 320. At decision diamond 320, the method evaluates whether media playback has been detected. The media playback determination is based on detection of active media devices such as televisions or streaming media players. If the answer at decision diamond 320 is YES, indicating that media playback has been detected, the method proceeds to dim lights and close window coverings 322.

At step 322, lights are dimmed and window coverings are closed to create an optimal media viewing environment. The dimming of lights reduces glare on screens and enhances the viewing experience, while closing window coverings blocks external light and provides privacy. After dimming lights and closing window coverings at step 322, the method proceeds to execute control commands 324.

If the answer at decision diamond 320 is NO, indicating that media playback has not been detected, the method proceeds directly to execute control commands 324. The three decision paths from steps 314, 318, and 322, along with the NO path from decision diamond 320, all converge at a junction point before proceeding to step 324.

At step 324, control commands are executed based on the determined activity state. All sensor data and automation decisions are processed locally within the residential structure. The local processing ensures that the method continues to function during network disruptions and maintains user privacy by avoiding transmission of sensor data to external servers. The control commands are transmitted to controlled subsystems including lighting systems, climate control systems, window covering systems, and audio systems.

Following execution of control commands at step 324, the method proceeds to end 326. However, the method operates in a continuous monitoring loop as indicated by the dashed line from end 326 back to detect occupancy 302. This continuous monitoring loop ensures that the method constantly evaluates occupancy and activity states, enabling real-time environmental adjustments as occupant activities change throughout the day.

The millimeter-wave radar sensor can be further configured to detect fall events by identifying rapid vertical position changes exceeding 1 meter occurring in less than 1 second, followed by sustained stationary occupancy at floor level for more than 30 seconds. Upon detecting a fall event, the control unit generates an alert condition transmitted to designated emergency contacts via the network interface or triggers audible/visual alerts within the residence to summon assistance from other occupants.

The flowchart illustrated in FIGS. 3A and 3B demonstrates the autonomous nature of the context-aware automation method, where environmental conditions are automatically adjusted based on detected activity states without requiring manual user input. The multiple decision points at steps 312, 316, and 320 enable the method to distinguish between different activity types and apply appropriate environmental adjustments for each activity. The local processing requirement at step 324 ensures privacy and reliability, while the continuous monitoring loop enables real-time responsiveness to changing occupant behaviors and needs.

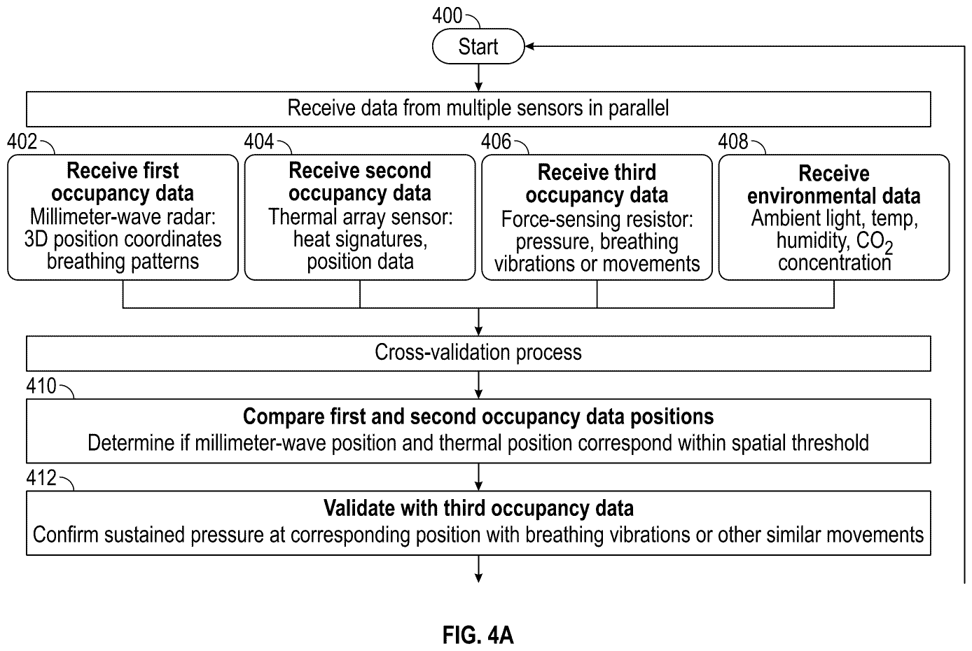

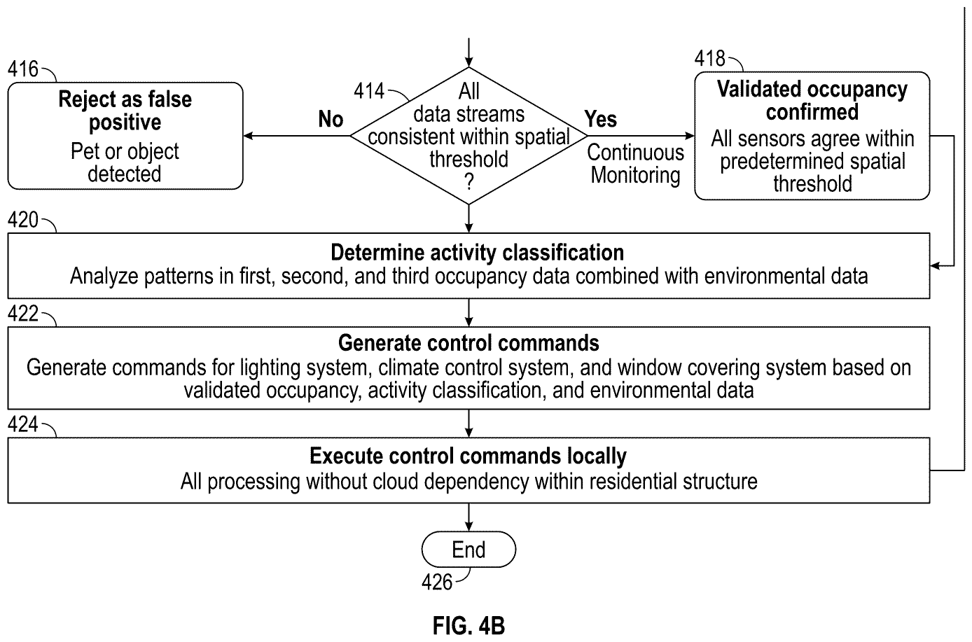

FIGS. 4A and 4B collectively illustrate a sensor fusion and cross-validation method flowchart corresponding to the sensor fusion method claims of the present invention. FIGS. 4A and 4B collectively depict the procedural steps for receiving data from multiple sensor types, cross-validating the sensor data to eliminate false positives, determining activity classifications, and generating control commands based on validated occupancy states.

The method begins at start 400 and proceeds to receive data from multiple sensors in parallel. The parallel data collection architecture enables simultaneous acquisition of sensor data from multiple sensing modalities, providing redundant and complementary information about the environment and occupants.

At step 402, first occupancy data is received from a millimeter-wave radar sensor positioned in a ceiling. The first occupancy data includes three-dimensional position coordinates generated by detecting chest movements corresponding to breathing patterns. The millimeter-wave radar sensor provides continuous monitoring of occupant positions and vital signs data, enabling detection of both moving and stationary occupants. The three-dimensional position coordinates specify the X, Y, and Z spatial locations of each detected occupant within the monitored space.

At step 404, second occupancy data is received from a thermal array sensor positioned in the ceiling. The second occupancy data includes heat signatures corresponding to human body temperature and position data derived from the thermal imaging. The thermal array sensor detects infrared radiation emitted by occupants and generates a heat map of the environment. The position data extracted from the thermal array sensor provides X and Y coordinates of detected heat sources, enabling comparison with the position coordinates from the millimeter-wave radar sensor.

At step 406, third occupancy data is received from a force-sensing resistor integrated into furniture. The third occupancy data includes pressure measurements and breathing vibrations detected by the force-sensing resistor. The force-sensing resistor provides definitive physical confirmation of occupancy when an occupant is seated or lying on furniture equipped with the sensor. The breathing vibrations detected through pressure variations enable the force-sensing resistor to distinguish between human occupants and inanimate objects of similar weight.

At step 408, environmental data is received from an environmental sensor cluster positioned in the ceiling. The environmental data includes at least ambient light levels, temperature, humidity, and CO₂ concentration. The environmental sensor cluster provides contextual information about ambient conditions that influence automation decisions. The environmental data is used in combination with occupancy data to determine appropriate environmental adjustments.

The data streams from steps 402, 404, 406, and 408 are received in parallel and converge for cross-validation processing. The parallel reception of multiple data streams enables real-time fusion of sensor information without sequential processing delays. After all data streams are received, the method proceeds to the cross-validation process.

At step 410, the first and second occupancy data positions are compared. The comparison determines whether the position coordinates from the millimeter-wave radar sensor and the position data from the thermal array sensor correspond within a predetermined spatial threshold. The predetermined spatial threshold accounts for normal variations in sensor accuracy and ensures that positions indicating the same occupant are properly correlated. For example, if the millimeter-wave radar sensor indicates an occupant at position (X1, Y1) and the thermal array sensor indicates a heat signature at position (X2, Y2), the comparison determines whether the distance between these positions is within the predetermined spatial threshold.

Following the comparison at step 410, the method proceeds to validate with third occupancy data 412. At step 412, the occupancy indicated by the first and second occupancy data is validated using the third occupancy data from the force-sensing resistor. The validation confirms sustained pressure at the corresponding position with breathing vibrations. This validation step provides ground truth confirmation that eliminates false positives from the millimeter-wave radar sensor and thermal array sensor. For example, if the millimeter-wave radar sensor and thermal array sensor both indicate an occupant on a couch, but the force-sensing resistor integrated into the couch detects no pressure, the occupancy indication is not validated.

After validation at step 412, the method proceeds to a decision point at decision diamond 414. At decision diamond 414, the method evaluates whether all data streams are consistent within the predetermined spatial threshold. This evaluation determines whether the first occupancy data, the second occupancy data, and the third occupancy data all indicate presence within the predetermined spatial threshold, confirming that all three sensor types agree on the occupancy state.

If the answer at decision diamond 414 is NO, indicating that the data streams are not consistent, the method proceeds to reject as false positive 416. At step 416, the occupancy indication is rejected as a false positive. The rejection indicates that the detected presence is attributable to a pet or an inanimate object rather than a human occupant requiring environmental adjustments. For example, if the millimeter-wave radar sensor detects movement and the thermal array sensor detects a heat signature, but the force-sensing resistor detects no pressure or detects pressure without breathing vibrations, the system determines that a pet has entered the monitored space. After rejecting the false positive at step 416, the method returns to the start 400 to continue monitoring, as indicated by the dashed line feedback path.

If the answer at decision diamond 414 is YES, indicating that all data streams are consistent within the predetermined spatial threshold, the method proceeds to validated occupancy confirmed 418. At step 418, validated occupancy is confirmed based on agreement of all sensors within the predetermined spatial threshold. The validated occupancy state represents a high-confidence determination that a human occupant is present at the indicated position and requires environmental control adjustments. The cross-validation process eliminates false positives that would occur if only a single sensor type were used.

After validated occupancy is confirmed at step 418, the method proceeds to determine activity classification 420. At step 420, an activity classification is determined by analyzing patterns in the first occupancy data, the second occupancy data, the third occupancy data, and the environmental data. The activity classification process evaluates multiple parameters including breathing rate from the first occupancy data, heat distribution patterns from the second occupancy data, pressure patterns and movement intensity from the third occupancy data, and ambient conditions from the environmental data. The combination of these parameters enables classification of activities such as sleeping, cooking, exercising, reading, media consumption, and general presence. For example, sustained pressure on a bed combined with slow breathing rate (12-15 breaths per minute) detected by the millimeter-wave radar sensor and minimal movement detected by the force-sensing resistor indicates a sleep activity classification.

Following activity classification at step 420, the method proceeds to generate control commands 422. At step 422, control commands are generated for at least a lighting system, a climate control system, and a window covering system. The control commands are generated based on the validated occupancy state determined at step 418, the activity classification determined at step 420, and the environmental data received at step 408. The generation of control commands involves mapping the activity classification to appropriate environmental settings. For example, a sleep activity classification triggers generation of control commands to dim lighting, reduce HVAC noise, and close window coverings. The environmental data influences the control commands by providing context such as ambient light levels that affect lighting control decisions and temperature that affects climate control decisions.

After generating control commands at step 422, the method proceeds to execute control commands locally 424. At step 424, the control commands are executed locally without cloud dependency within the residential structure. All processing of sensor data, cross-validation, activity classification, and control command generation occurs on a local control unit, ensuring privacy and enabling continued operation during network disruptions. The local execution transmits the control commands to the controlled subsystems via local communication protocols.

Following execution of control commands at step 424, the method proceeds to end 426. However, the method operates in a continuous monitoring loop as indicated by the line from end 426 back to start 400. This continuous monitoring loop ensures that the sensor fusion and cross-validation process operates continuously, providing real-time validation of occupancy states and enabling immediate detection of changes in occupancy or activity classifications.

The flowchart illustrated in FIGS. 4A and 4B demonstrates the sensor fusion architecture where multiple complementary sensor types provide redundant occupancy information that is cross-validated to eliminate false positives. The decision point at step 414 enables the method to distinguish between human occupants and pets or inanimate objects by requiring agreement among multiple sensor modalities. With respect to pets, robot vacuums or other similar objects, while the radar cross-section can help determine what is a pet or a human (as mentioned in prior sections), so can the distance of that pet from the sensor. Due to their height, humans are detected closer to the sensor than pets. It will be understood that the 3-axis nature of the mm Wave sensors allows for this measurement.

The validated occupancy state provides high-confidence occupancy information that enables reliable automation without false triggering from pets or environmental factors. The integration of environmental data with occupancy data enables context-aware control decisions that account for both occupant activities and ambient conditions. The local processing requirement ensures privacy by avoiding transmission of sensor data to external servers while maintaining system reliability during network disruptions.

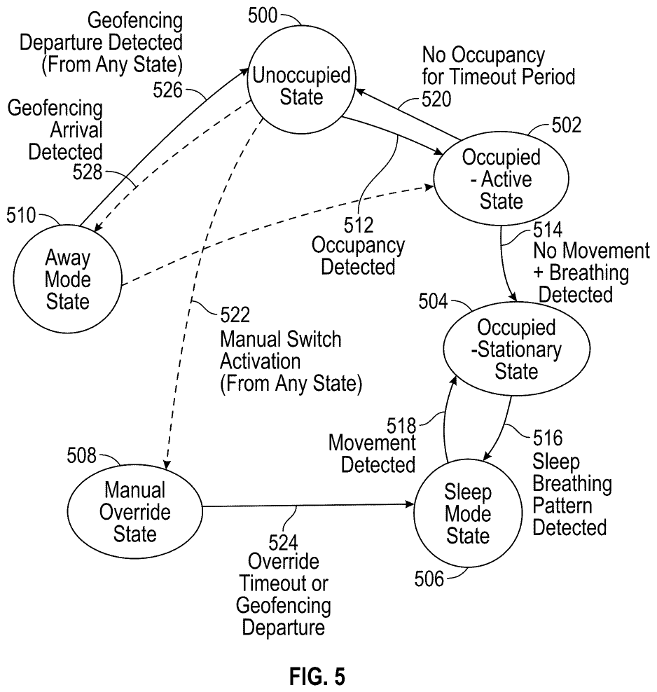

FIG. 5 illustrates an automation states and transitions diagram for the building automation system. FIG. 5 depicts the various operational states of the system and the conditions that trigger transitions between states, demonstrating the autonomous state management capabilities of the context-aware automation system.

The building automation system operates in six distinct states, each corresponding to a different occupancy and control mode. The system automatically transitions between states based on sensor inputs, occupancy patterns, manual user interventions, and geofencing data. The state diagram illustrates both direct state transitions based on sensor input and universal transitions that can occur from any state.

The unoccupied state 500 represents the baseline operational mode when no occupants are detected in the monitored space. In the unoccupied state 500, the system operates in an energy-saving mode with minimal lighting and reduced HVAC activity. The lighting system maintains lights in an off state or at minimal levels for safety purposes. The climate control system operates in an energy-efficient mode that maintains the space within broader temperature thresholds than would be maintained during occupied periods. The window covering system may be positioned to optimize passive solar heating or cooling based on time of day and weather conditions.

The occupied—active state 502 represents the operational mode when occupants are detected with movement activity. In the occupied—active state 502, the system provides normal lighting levels appropriate for the time of day and solar schedule. The climate control system operates to maintain comfortable temperature and humidity levels based on occupancy patterns. The lighting system adjusts brightness and color temperature according to circadian lighting principles, providing cooler, brighter lighting during daytime hours and warmer, dimmer lighting during evening hours. The audio system is enabled to play notifications in occupied zones. All controlled subsystems operate in their normal automated modes, responding to real-time occupancy and environmental conditions.

The occupied—stationary state 504 represents the operational mode when occupants are present but have ceased movement. In the occupied—stationary state 504, occupants remain in fixed positions and are detected through breathing patterns measured by the millimeter-wave radar sensor. The system maintains comfort conditions without assuming that the space is unoccupied. The lighting system continues to provide appropriate illumination for the detected activity. The climate control system maintains comfortable conditions. The occupied—stationary state 504 prevents the system from incorrectly transitioning to the unoccupied state 500 when occupants are present but motionless, such as when reading, working at a desk, or watching media.

The sleep mode state 506 represents the operational mode when occupants are detected to be sleeping based on breathing patterns. In the sleep mode state 506, the system creates an optimal sleeping environment by dimming or turning off lights, reducing HVAC noise levels while maintaining optimal sleeping temperatures, and closing window coverings for privacy and light blocking. The lighting system may activate soft red ambient lighting for nighttime navigation without disrupting sleep. The audio system mutes notifications or routes them only to non-sleeping zones. The climate control system maintains temperatures in a range conducive to sleep, typically cooler than daytime temperature settings. The sleep mode state 506 provides specialized environmental control optimized for rest and sleep quality.

The manual override state 508 represents the operational mode when a user has manually adjusted one or more controlled subsystems. In the manual override state 508, automated control is suspended for the affected subsystem to respect the user's manual intervention. The system continues to monitor the manually adjusted subsystem but does not generate automated control commands that would conflict with the user's settings. For example, if a user manually adjusts a thermostat, the climate control system enters the manual override state 508 and ceases automated temperature adjustments until the override is cleared. Other subsystems not subject to manual intervention continue operating in their normal automated modes. The manual override state 508 ensures that the system respects user preferences when users choose to take direct control of environmental settings.

The away mode state 510 represents the operational mode when geofencing indicates that users have departed the residential structure. In the away mode state 510, the system operates in maximum energy-saving mode while maintaining security and preparing for the users'return. The lighting system turns off all lights or maintains minimal security lighting. The climate control system operates in energy-saving mode with wider temperature thresholds. All manual overrides are automatically cleared when entering the away mode state 510. The system monitors geofencing data to detect when users are approaching and can activate pre-conditioning routines to prepare the environment before arrival. The away mode state 510 provides both energy savings during absences and intelligent preparation for return.

The system transitions between states based on specific trigger conditions. Transition 512 represents the transition from the unoccupied state 500 to the occupied—active state 502. Transition 512 is triggered when occupancy is detected by the sensor module. When the millimeter-wave radar sensor or thermal array sensor detects the presence of an occupant, the system immediately transitions from the unoccupied state 500 to the occupied—active state 502, activating appropriate lighting, adjusting climate control to comfort settings, and enabling audio notifications in the occupied zone.

Transition 514 represents the transition from the occupied—active state 502 to the occupied—stationary state 504. Transition 514 is triggered when no movement is detected but breathing patterns are detected by the millimeter-wave radar sensor. This transition occurs when an occupant becomes stationary, such as when sitting down to read or work. The detection of breathing movements prevents the system from incorrectly assuming that the space has become unoccupied.

Transition 516 represents the transition from the occupied—stationary state 504 to the sleep mode state 506. Transition 516 is triggered when a sleep breathing pattern is detected. The sleep breathing pattern is characterized by breathing rates in a predetermined sleep range, typically 12-15 breaths per minute, combined with sustained stationary occupancy in a location associated with sleeping, such as a bed. When these conditions are met, the system automatically transitions to sleep mode state 506 and adjusts environmental conditions to support continued sleep.

Transition 518 represents the transition from the sleep mode state 506 to the occupied—active state 502. Transition 518 is triggered when movement is detected, indicating that the occupant has awakened. The millimeter-wave radar sensor detects increased movement activity and changes in breathing patterns consistent with wakefulness. When awakening is detected, the system transitions to the occupied—active state 502 and may implement a morning routine that gradually increases lighting levels and adjusts climate control to daytime settings.

Transition 520 represents the transition from the occupied—active state 502 to the unoccupied state 500. Transition 520 is triggered when no occupancy is detected for a predetermined timeout period. If the sensor module detects no presence for the timeout period, which may be on the order of minutes, the system concludes that occupants have left the space and transitions to the unoccupied state 500. This transition enables energy-saving operation when spaces are genuinely unoccupied.

Transition 522 represents a universal transition from any state to the manual override state 508. Transition 522 is triggered when manual switch activation is detected. The transition 522 is illustrated with a dashed line to indicate that it can occur from any of the other states. When the system detects that a user has manually adjusted a wall switch, thermostat, or other control interface, the affected subsystem transitions to the manual override state 508 regardless of the system's prior state. This universal transition ensures that manual user control is always respected.

Transition 524 represents the transition from the manual override state 508 back to a prior automated state. Transition 524 is triggered by either override timeout or geofencing departure detection. The override timeout is a predetermined time period, such as 30 minutes to several hours, after which the system assumes that the manual adjustment was temporary and resumes automated control. Alternatively, when geofencing detects that the user has departed the residential structure, all manual overrides are immediately cleared and the system returns to automated operation. Transition 524 enables the system to resume intelligent automation after temporary manual interventions.

Transition 526 represents a universal transition from any state to the away mode state 510. Transition 526 is triggered when geofencing departure is detected. The transition 526 is illustrated with a dashed line to indicate that it can occur from any of the other states. When the geofencing system detects that all users have departed the residential structure based on location tracking of mobile devices or wearables, the system immediately transitions to the away mode state 510 regardless of prior state. This universal transition ensures rapid transition to energy-saving operation upon departure.

Transition 528 represents the transition from the away mode state 510 to the unoccupied state 500. Transition 528 is triggered when geofencing arrival is detected. When the geofencing system detects that users are returning to the residential structure, the system exits the away mode state 510 and transitions to the unoccupied state 500, preparing to detect occupancy and transition to an occupied state. This transition may trigger pre-conditioning routines that begin adjusting temperature before occupancy is actually detected.

Transition 530 represents a direct transition from the away mode state 510 to the occupied—active state 502. Transition 530 is triggered by arrival combined with immediate occupancy detection. The transition 530 is illustrated with a dotted line to indicate that it is a conditional transition with pre-conditioning. When geofencing indicates imminent arrival and the sensor module immediately detects occupancy upon entry, the system bypasses the unoccupied state 500 and transitions directly to the occupied—active state 502. This transition is associated with pre-conditioning activities where the climate control system activates before arrival based on estimated arrival time calculated from geofencing velocity and direction data.

The state diagram illustrated in FIG. 5 demonstrates the intelligent state management capabilities of the building automation system. The multiple states enable the system to optimize environmental control for different occupancy situations, from unoccupied energy-saving operation to specialized sleep mode settings. The automatic state transitions based on sensor inputs enable the system to respond to changing occupancy and activity patterns without manual user input. The manual override state 508 and associated transitions 522 and 524 demonstrate that the system respects user control while intelligently resuming automation when appropriate. The away mode state 510 and associated transitions 526, 528, and 530 demonstrate integration with geofencing to provide both energy savings during absences and intelligent pre-conditioning before arrivals. The state transition architecture enables seamless adaptation to occupant behaviors throughout daily and weekly cycles while maintaining energy efficiency and user comfort.

In some embodiments, the system provides whole-building automations coordinated across zones. A controller uses geofencing to pre-condition climate before occupant arrival, manages circadian lighting sequences, and allocates heating and cooling by zone based on detected occupancy. Environmental sensors monitor radon, particulates, and volatile compounds; leak and moisture sensors trigger audible or visual alerts and may actuate a shutoff valve. Safety behaviors include motion-responsive stair lighting, emergency egress lighting during power loss, and accessible doorbell cues via audio and light. Acoustic management adjusts room gain and equalization by occupancy, while scheduled scenes, including holiday themes, execute from a calendar without user intervention.

In some embodiments, a bedroom subsystem orchestrates wake and sleep sequences. As a wake window begins, the controller gradually opens draperies based on sun position, raises illuminance toward a biologically appropriate spectrum, and brings the room to a target temperature. A goodnight routine secures entry points, enables white noise, and holds climate at a sleep setpoint independent of motion so lights do not time out during stillness. Wardrobe task lighting provides color-accurate rendering and may be addressed per side of the bed to avoid disturbing a partner. More generally, equivalent routines can be applied in any zone type using any combination of the disclosed sensors and controllers, with commands mapped to the controlled resources available in that zone.

In bedroom embodiments with force-sensing resistors integrated into both sides of a bed, the system distinguishes between bedside A and bedside B occupancy. The millimeter-wave radar sensor orientation is calibrated during installation to align its X-axis with the bed's length and Y-axis with the bed's width. Position coordinates from the radar combined with pressure data from FSRs enable the context analyzer to determine which side of the bed is occupied. When pressure is detected on bedside A but not bedside B, indicating one occupant has risen while the other remains sleeping, the automation logic generates asymmetric control commands: pathway lighting activates to guide the risen occupant while bedroom lighting remains off to avoid disturbing the sleeping partner, and HVAC adjustments minimize noise levels.

In one embodiment, when a mmWave sensor is used, the mmWave sensor can distinguish A and B side occupancy. The force sensor can help validate these states if necessary. One example of where a force sensor can be used is in a project with high-loft vaulted ceilings that could interfere with mmWave readings. In this case, the force sensor could provide exclusive occupancy data or, through sensor fusion, validate it.

In some embodiments, a bathroom subsystem emphasizes safety and comfort. Low-level path lights are activated from mmWave sensing during nocturnal entries, while floor heating elements are pre-heated according to a user schedule. A humidity sensor drives closed-loop control of the exhaust fan until the relative humidity returns to baseline. Grooming and shower scenes apply distinct correlated color temperatures and intensities to reduce glare and improve task visibility. In other instances, passive infrared sensors can be used. More generally, equivalent routines can be applied in any zone type using any combination of the disclosed sensors and controllers, with commands mapped to the controlled resources available in that zone.

In some embodiments, a kitchen subsystem automates task readiness and ambience. Proximity sensing increases task lighting over work surfaces as a user approaches, while a scheduled routine pre-warms or actuates a coffee appliance at a defined time. During prep or entertaining, the audio subsystem loads a designated playlist and maintains intelligible background levels relative to detected noise and occupancy. More generally, equivalent routines can be applied in any zone type using any combination of the disclosed sensors and controllers, with commands mapped to the controlled resources available in that zone.

In some embodiments, a home-gym subsystem enhances workout engagement and thermal comfort. On detection of activity, the controller drives high-intensity, high-contrast lighting, starts a predefined music program, and increases ventilation or fan speed to maintain a target operative temperature. Post-workout, a cooldown routine gradually reduces light levels and restores baseline airflow. The system can also incorporate data obtained from heartrate and/or breathing sensors.

In some embodiments, living areas maintain comfort and media-friendly conditions without manual input. Presence tracking hands off climate and audio between adjacent spaces to avoid hot and cold spots and to eliminate overlapping sound fields. Window covers respond to solar angle, interior luminance, and space temperature to balance daylight with artificial lighting throughout the day. A circadian profile modulates spectrum and intensity to support alertness by day and relaxation in the evening. More generally, equivalent routines can be applied in any zone type using any combination of the disclosed sensors and controllers, with commands mapped to the controlled resources available in that zone.

In some embodiments, a dining area exposes scene presets keyed to context. A small-group preset lowers illuminance and warms spectrum for intimate meals, while a hosting preset raises ambient light for service and conversation. The climate loop compensates for added metabolic load as guests arrive, and whole-home audio provides curated playlists at conversational levels.

In some embodiments, a home-office subsystem supports cognitive work and air quality. The controller maintains a focus-oriented light recipe with high vertical illuminance and neutral-cool spectrum, monitors indoor CO₂, and increases outdoor-air exchange when thresholds are exceeded. Climate follows a workday schedule with pre-start pre-conditioning and after-hours setback. Ambient cues provide posture and break reminders without audible interruptions.

In some embodiments, a nursery subsystem emphasizes quiet supervision. A sensor module monitors motion and temperature and issues notifications when values exceed bounds. Night-check behaviors enable a very low-level path light on caregiver entry and then fade it out automatically. Nap and bedtime routines provide gradual dimming and soft audio to smooth transitions to sleep.

In some embodiments, an entertainment room coordinates with media state. Media detection triggers bias lighting and closes shades to minimize screen glare, while an A/V integration adjusts audio levels and equalization for movie, game, or music modes. When playback is paused, low-level ambient lighting raises just enough to permit safe movement without disturbing others.

In some embodiments, a garage subsystem uses location context for secure access. As an authorized device enters a geofence, the controller commands the bay door to open and illuminates the ingress path; upon departure it closes and locks the door and arms the attached sensor suite. Fault conditions such as obstruction or prolonged open states generate immediate alerts.

In some embodiments, a foyer or entryway serves as a handoff zone between exterior and interior states. Proximity or recognized identity can trigger a welcome scene that unlocks the door, brings up pathway lighting to primary rooms, and opens a coat-closet light. The subsystem records an arrival event and synchronizes with the security and video doorbell modules.

In some embodiments, a laundry room is instrumented for appliance state and moisture management. The controller monitors cycle progress and provides completion notifications to designated endpoints. A humidity or temperature rise from dryers or steam cycles automatically actuates ventilation until baseline conditions are restored.

In some embodiments, a wine cellar maintains preservation conditions while providing display lighting. Temperature and humidity sensors feed a control loop that holds narrow setpoints appropriate to the collection. Accent luminaires operate at spectra and intensities that minimize heat and UV load while still rendering labels legibly.

In some embodiments, outdoor spaces respond to weather and time of day. Awnings or shades retract or deploy based on wind and irradiance, patio heaters modulate to maintain comfort, and landscape lighting follows astronomical events for on and off times. Irrigation scheduling ingests forecast data and soil moisture to avoid redundant watering.

In some embodiments, window-centric zones use sun-tracking to protect interiors and reduce HVAC load. Shade motors position fabric relative to solar altitude and azimuth while maintaining view preferences, with transitions coordinated to avoid banding or flicker. UV exposure limits for sensitive artwork or textiles can trigger a protective mode that reduces irradiance without fully darkening the space.

In some embodiments, an entire-home alerting and resilience layer spans all rooms. The system prioritizes safety events, including unexpected access, water leaks, and power loss, and issues multimodal alerts while actuating protective responses such as water shutoff or lighting designated egress paths. Noncritical notifications are deferred or summarized to reduce nuisance, and all routines may be scheduled, conditionally triggered, or temporarily suspended to accommodate occupant preferences.

In certain embodiments, the system further comprises moisture sensors positioned adjacent to water-using appliances including water heaters, washing machines, dishwashers, and under sinks, and a motorized valve actuator installed on the main water supply line. The moisture sensors detect resistance changes indicating presence of water. Upon detecting a leak condition, the control unit commands the motorized valve to close the main water supply, generates audible and visual alerts via the audio system and lighting system in occupied zones, and transmits notification to designated contacts. The moisture sensors distinguish between temporary surface moisture (e.g., from cleaning) and sustained leaks by requiring moisture detection for more than two minutes before triggering shutoff.

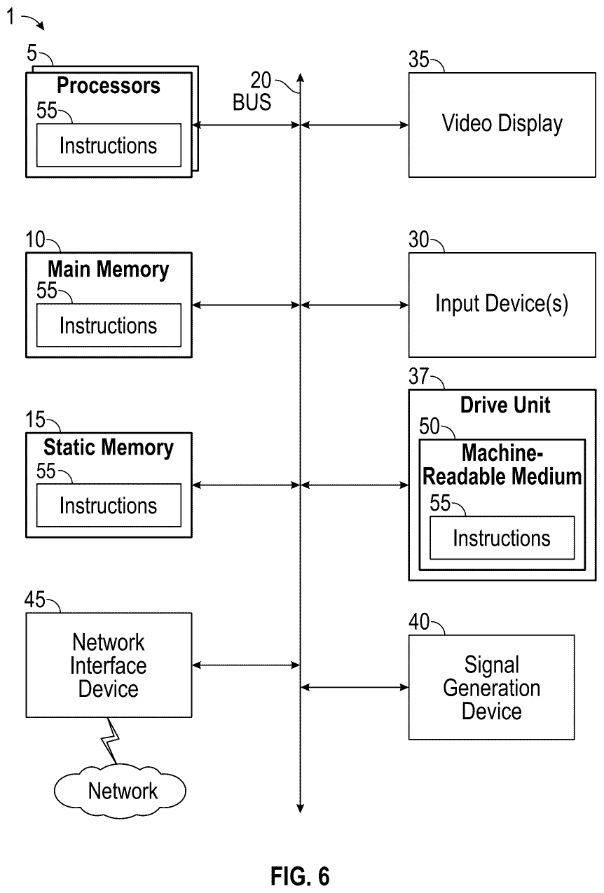

FIG. 6 is a diagrammatic representation of an example machine in the form of a computer system 1, within which a set of instructions for causing the machine to perform any one or more of the methodologies discussed herein may be executed. In various example embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), Single Board Computer (SBC), a personal digital assistant (PDA), a cellular telephone, a portable music player (e.g., a portable hard drive audio device such as a Moving Picture Experts Group Audio Layer 3(MP3 ) player), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The computer system 1 includes a processor or multiple processor(s) 5 (e.g., a central processing unit (CPU), a graphics processing unit (GPU), or both), and a main memory 10 and static memory 15, which communicate with each other via a bus 20. The computer system 1 may further include a video display 35 (e.g., a liquid crystal display (LCD)). The computer system 1 may also include an alpha-numeric input device(s) 30 (e.g., a keyboard), a cursor control device (e.g., a mouse), a voice recognition or biometric verification unit (not shown), a drive unit 37 (also referred to as disk drive unit), a signal generation device 40 (e.g., a speaker), and a network interface device 45. The computer system 1 may further include a data encryption module (not shown) to encrypt data.

The drive unit 37 includes a computer or machine-readable medium 50 on which is stored one or more sets of instructions and data structures (e.g., instructions 55) embodying or utilizing any one or more of the methodologies or functions described herein. The instructions 55 may also reside, completely or at least partially, within the main memory 10 and/or within the processor(s) 5 during execution thereof by the computer system 1. The main memory 10 and the processor(s) 5 may also constitute machine-readable media.

The instructions 55 may further be transmitted or received over a network via the network interface device 45 utilizing any one of a number of well-known transfer protocols (e.g., Hyper Text Transfer Protocol (HTTP)). While the machine-readable medium 50 is shown in an example embodiment to be a single medium, the term “computer-readable medium” should be taken to include a single medium or multiple media (e.g., a centralized or distributed database and/or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAM), read only memory (ROM), and the like. The example embodiments described herein may be implemented in an operating environment comprising software installed on a computer, in hardware, or in a combination of software and hardware. Where appropriate, the functions described herein can be performed in one or more of hardware, software, firmware, digital components, or analog components. For example, the encoding and or decoding systems can be embodied as one or more application specific integrated circuits (ASICs) or microcontrollers that can be programmed to carry out one or more of the systems and procedures described herein. Certain terms are used throughout the description and claims refer to particular system components. As one skilled in the art will appreciate, components may be referred to by different names. This document does not intend to distinguish between components that differ in name, but not function.

One skilled in the art will recognize that the Internet service may be configured to provide Internet access to one or more computing devices that are coupled to the Internet service, and that the computing devices may include one or more processors, buses, memory devices, display devices, input/output devices, and the like. Furthermore, those skilled in the art may appreciate that the Internet service may be coupled to one or more databases, repositories, servers, and the like, which may be utilized in order to implement any of the embodiments of the disclosure as described herein.

The corresponding structures, materials, acts, and equivalents of all means or step plus function elements in the claims below are intended to include any structure, material, or act for performing the function in combination with other claimed elements as specifically claimed. The description of the present technology has been presented for purposes of illustration and description, but is not intended to be exhaustive or limited to the present technology in the form disclosed. Many modifications and variations will be apparent to those of ordinary skill in the art without departing from the scope and spirit of the present technology. Exemplary embodiments were chosen and described in order to best explain the principles of the present technology and its practical application, and to enable others of ordinary skill in the art to understand the present technology for various embodiments with various modifications as are suited to the particular use contemplated.

If any disclosures are incorporated herein by reference and such incorporated disclosures conflict in part and/or in whole with the present disclosure, then to the extent of conflict, and/or broader disclosure, and/or broader definition of terms, the present disclosure controls. If such incorporated disclosures conflict in part and/or in whole with one another, then to the extent of conflict, the later-dated disclosure controls.

The terminology used herein can imply direct or indirect, full or partial, temporary or permanent, immediate or delayed, synchronous or asynchronous, action or inaction. For example, when an element is referred to as being “on,” “connected” or “coupled” to another element, then the element can be directly on, connected or coupled to the other element and/or intervening elements may be present, including indirect and/or direct variants. In contrast, when an element is referred to as being “directly connected” or “directly coupled” to another element, there are no intervening elements present.

The terminology used herein is for the purpose of describing particular embodiments only and is not intended to be necessarily limiting of the disclosure. As used herein, the singular forms “a,” “an” and “the” are intended to include the plural forms as well, unless the context clearly indicates otherwise. The terms “comprises,” “includes” and/or “comprising,” “including” when used in this specification, specify the presence of stated features, integers, steps, operations, elements, and/or components, but do not preclude the presence or addition of one or more other features, integers, steps, operations, elements, components, and/or groups thereof.

Example embodiments of the present disclosure are described herein with reference to illustrations of idealized embodiments (and intermediate structures) of the present disclosure. As such, variations from the shapes of the illustrations as a result, for example, of manufacturing techniques and/or tolerances, are to be expected. Thus, the example embodiments of the present disclosure should not be construed as necessarily limited to the particular shapes of regions illustrated herein, but are to include deviations in shapes that result, for example, from manufacturing.

Aspects of the present technology are described above with reference to flowchart illustrations and/or block diagrams of methods, apparatus (systems) and computer program products according to embodiments of the present technology. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

In this description, for purposes of explanation and not limitation, specific details are set forth, such as particular embodiments, procedures, techniques, etc. in order to provide a thorough understanding of the present disclosure. However, it will be apparent to one skilled in the art that the present disclosure may be practiced in other embodiments that depart from these specific details.

Reference throughout this specification to “one embodiment” or “an embodiment” means that a particular feature, structure, or characteristic described in connection with the embodiment is included in at least one embodiment of the present disclosure. Thus, the appearances of the phrases “in one embodiment” or “in an embodiment” or “according to one embodiment” (or other phrases having similar import) at various places throughout this specification are not necessarily all referring to the same embodiment. Furthermore, the particular features, structures, or characteristics may be combined in any suitable manner in one or more embodiments. Furthermore, depending on the context of discussion herein, a singular term may include its plural forms and a plural term may include its singular form. Similarly, a hyphenated term (e.g., “on-demand”) may be occasionally interchangeably used with its non-hyphenated version (e.g., “on demand”), a capitalized entry (e.g., “Software”) may be interchangeably used with its non-capitalized version (e.g., “software”), a plural term may be indicated with or without an apostrophe (e.g., PE's or PEs), and an italicized term (e.g., “N+1”) may be interchangeably used with its non-italicized version (e.g., “N+1”). Such occasional interchangeable uses shall not be considered inconsistent with each other.

Also, some embodiments may be described in terms of “means for” performing a task or set of tasks. It will be understood that a “means for” may be expressed herein in terms of a structure, such as a processor, a memory, an I/O device such as a camera, or combinations thereof. Alternatively, the “means for” may include an algorithm that is descriptive of a function or method step, while in yet other embodiments the “means for” is expressed in terms of a mathematical formula, prose, or as a flow chart or signal diagram.

What is claimed is:

1. A system, comprising:
a sensor module positioned in a wall of a structure, the sensor module comprising:
a millimeter-wave radar sensor configured to detect stationary occupants by measuring chest movements corresponding to breathing patterns, wherein the millimeter-wave radar sensor generates three-dimensional position coordinates for each detected occupant;
a thermal array sensor having a low resolution configured to generate heat signatures of occupants in the structure; and
an ambient light sensor configured to measure ambient light levels;
a control unit operatively coupled to the sensor module and configured to receive and process sensor data from the millimeter-wave radar sensor, the thermal array sensor, and the ambient light sensor;
a lighting system operatively connected to the control unit, wherein the control unit is configured to:
adjust brightness and color temperature of the lighting system based on a solar schedule determined from GPS coordinates and time of day; and
automatically prevent activation of the lighting system when the ambient light sensor detects ambient light levels exceeding a predetermined threshold despite detecting occupancy via the millimeter-wave radar sensor;
a window covering system operatively connected to the control unit and configured to automatically adjust window coverings based on detected user routines and external environmental conditions;
a climate control system operatively connected to the control unit and configured to adjust temperature and humidity based on occupancy patterns detected by the millimeter-wave radar sensor; and
an audio system integrated with the control unit and configured to play audio notifications selectively in rooms with detected occupancy, wherein the control unit processes sensor data locally within a residential structure, enabling continued operation during network disruptions.

2. The building automation system of claim 1, wherein the millimeter-wave radar sensor operates in a frequency range of 57-64 GHz.

3. The building automation system of claim 1, wherein the thermal array sensor has a resolution of low resolution pixels.

4. The building automation system of claim 1, wherein the ambient light sensor is configured to measure ambient light levels in a range of 1-65,535 lux.

5. The building automation system of claim 1, wherein the sensor module further comprises a force-sensing resistor integrated into furniture, and wherein the control unit is configured to validate occupancy detected by the millimeter-wave radar sensor using pressure data from the force-sensing resistor.

6. The building automation system of claim 1, wherein the control unit initiates pre-conditioning of a designated zone when an authorized device enters a geofence radius and restores a setback state upon departure.

7. The building automation system of claim 1, wherein the millimeter-wave radar sensor is further configured to measure breathing rate and heart rate of detected occupants without physical contact, and wherein the control unit is configured to activate a sleep mode when detecting breathing rates in a predetermined sleep range combined with sustained stationary occupancy.

8. The building automation system of claim 1, wherein the control unit is further configured to:
track a direction of travel and velocity of a user via geofencing;
activate the climate control system to pre-condition the residential structure before the user arrives based on calculated arrival time; and
automatically clear any manual overrides to the lighting system, the window covering system, or the climate control system when the user departs the residential structure.

9. The building automation system of claim 1, wherein the millimeter-wave radar sensor is configured to distinguish between adults, children, and pets by analyzing radar cross-section signatures, and wherein the audio system is configured to mute audio notifications in rooms where the millimeter-wave radar sensor detects a child-sized radar cross-section combined with breathing patterns indicating sleep.

10. A method for context-aware building automation, the method comprising:
detecting occupancy in a room using a millimeter-wave radar sensor, wherein the detecting includes measuring chest movements corresponding to breathing patterns to detect stationary occupants;
generating three-dimensional position coordinates for each detected occupant using the millimeter-wave radar sensor;
detecting heat signatures of the detected occupants using a thermal array sensor having a low resolution;
determining a current activity state of the detected occupants by analyzing at least:
breathing rate measured by the millimeter-wave radar sensor,
duration of stationary occupancy measured by the millimeter-wave radar sensor, and
movement pattern intensity measured by the millimeter-wave radar sensor;
automatically adjusting environmental conditions in the room based on the determined activity state without requiring manual user input, wherein the adjusting includes:
activating a sleep mode comprising dimming lights and reducing HVAC activity when the breathing rate is in a predetermined sleep range and the stationary occupancy exceeds a predetermined duration threshold;
increasing lighting intensity when the movement pattern intensity in a kitchen area exceeds a predetermined threshold for a predetermined time period indicating cooking activity; and
dimming lights and closing window coverings when detecting media playback; and
processing all sensor data and automation decisions locally within a residential structure.

11. The method of claim 10, wherein the millimeter-wave radar sensor operates in a frequency range of 57-64 GHz.

12. The method of claim 10, wherein the thermal array sensor has a resolution of 510 total pixels or less.

13. The method of claim 10, wherein the predetermined sleep range is 12-15 breaths per minute.

14. The method of claim 10, further comprising:
measuring ambient light levels using an ambient light sensor;
determining that the ambient light levels exceed a predetermined threshold; and
preventing activation of artificial lighting despite detecting occupancy when the ambient light levels exceed the predetermined threshold.

15. The method of claim 10, further comprising:
detecting pressure on furniture using a force-sensing resistor integrated into the furniture;
detecting breathing vibrations through pressure variations measured by the force-sensing resistor; and
validating the occupancy detected by the millimeter-wave radar sensor using pressure data from the force-sensing resistor to eliminate false positive detections.

16. A method for automated environmental control using sensor fusion, the method comprising:
receiving first occupancy data from a millimeter-wave radar sensor positioned in a ceiling, wherein the first occupancy data includes three-dimensional position coordinates generated by detecting chest movements corresponding to breathing patterns;
receiving second occupancy data from a thermal array sensor positioned in the ceiling, wherein the second occupancy data includes heat signatures corresponding to human body temperature;
receiving third occupancy data from a force-sensing resistor integrated into furniture, wherein the third occupancy data includes pressure measurements and breathing vibrations;
receiving environmental data from an environmental sensor cluster positioned in the ceiling, wherein the environmental data includes at least ambient light levels, temperature, humidity, and carbon dioxide concentration;
determining a validated occupancy state by cross-validating the first occupancy data, the second occupancy data, and the third occupancy data, wherein the cross-validating eliminates false positive occupancy detections from pets or inanimate objects;
determining an activity classification by analyzing patterns in the first occupancy data, the second occupancy data, the third occupancy data, and the environmental data;
automatically generating control commands for at least a lighting system, a climate control system, and a window covering system based on the validated occupancy state, the activity classification, and the environmental data; and
executing the control commands locally without cloud processing.

17. The method of claim 16, wherein the heat signatures corresponding to human body temperature are within a human-thermal band of approximately 30 to 40° C.

18. The method of claim 16, wherein the determining the activity classification comprises:
detecting that the first occupancy data indicates a breathing rate in a predetermined sleep range;
detecting that the third occupancy data indicates sustained pressure on a bed with breathing vibrations; and
classifying the activity as sleep based on the breathing rate and the sustained pressure with breathing vibrations.

19. The method of claim 18, wherein the predetermined sleep range is 12-15 breaths per minute.

20. The method of claim 16, further comprising:
detecting manual intervention with the lighting system by monitoring for changes in lighting state not initiated by the control commands;
suspending generation of lighting control commands for a predetermined time period in response to detecting the manual intervention;
tracking user location via geofencing; and
resuming generation of lighting control commands when geofencing indicates the user has departed a residential structure, automatically clearing the manual intervention.
